(19) United States
(12) Patent Application Publication
(10) Pub. No.: US 2025/0132832 A1
(43) Pub. Date: Apr. 24, 2025

(54) METHOD AND SYSTEM FOR OPTICAL TRANSMISSION BETWEEN FIRST AND SECOND DEVICES WITH DETERMINATION OF THE LOCATION OF THE SECOND DEVICE

(71) Applicant: Orange, Issy-les-Moulineaux (FR)

(72) Inventors: Olivier Bouchet, Chatillon (FR); Bruno Jahan, Chatillon (FR)

(21) Appl. No.: 18/719,201

(22) PCT Filed: Dec. 16, 2022
(86) PCT No.: PCT/EP2022/086509

§ 371 Date: Jun. 12, 2024

(30) Foreign Application Priority Data
Dec. 22, 2021 (FR) FR2114219

(51) Int. Cl. H04B 10/114; G01S 3/782

(52) U.S. Cl. CPC H04B 10/1143; G01S 3/782

(57) ABSTRACT

A method is described for optical communication of data between a first telecommunication device at a known location and a second telecommunication device, the first device including an optical fiber carrying a light beam and a removable mirror controlled by a microprocessor in order to direct the light beam at the output of the optical fiber in a first direction. The method includes controlling the removable mirror by the microprocessor in order to align the first direction with the direction of reception, and determining by the microprocessor the location of the second device, knowing the location of the first device, the relative height between the two devices and the vertical and horizontal inclination angles of the mirror.

### FIELD OF THE INVENTION

The present invention relates to the field of telecommunications. Within this field, the invention relates more particularly to methods for the optical transmission of data from a first telecommunications equipment to a second equipment. It is applicable in particular to virtual reality devices. In this context, the invention makes it possible to obtain the position of one or more users distributed in an environment, which positions will be used to interact with a virtual reality content item.

### PRIOR ART

An optical data communication system comprising at least one access point and an optical headset is known. The access point comprises:
an optical fiber carrying a light beam,
a movable mirror,
a microprocessor for driving the orientation of the mirror at vertical and horizontal tilt angles so as to direct the light beam at the output of the optical fiber in a first direction, a photoreceiver array for receiving a luminous flux from an emitting source associated with the headset and for determining a first direction of reception.

The optical headset comprises:
an optical fiber carrying a light beam,
a movable mirror,
a microprocessor for driving the orientation of the mirror at vertical and horizontal tilt angles so as to direct the light beam at the output of the optical fiber in a second direction,
a photoreceiver array for receiving a luminous flux from an emitting source associated with the access point and for determining a second direction of reception.

The microprocessor of the access point is programmed to align the first direction with the first direction of reception. The microprocessor of the headset is programmed to align the second direction with the second direction of reception.

In a virtual reality context, the virtual reality data are transmitted by the access point to the headset. Such use requires a very high data transmission rate. For the user to benefit from total immersion, they should not perceive any interruption when they move; communication therefore has to be maintained even in the event of a handover from one access point to another access point. In addition, when multiple users are distributed in an enclosed space with multiple access points, they should each be able to benefit from the same sensation of total immersion.

### SUMMARY OF THE INVENTION

The invention proposes a communication method aimed at improving the sensation of immersion for the user of the second equipment, for example a headset.

One subject of the invention is a method for optical data communication between a first telecommunications equipment the location of which is known and a second telecommunications equipment, the first equipment being equipped with an optical fiber carrying a light beam and with a movable mirror driven by a microprocessor so as to direct the light beam at the output of the optical fiber in a first direction, and being equipped with a photoreceiver array for receiving a luminous flux carrying an identifier from the second equipment and for determining a direction of reception, comprising:
using the microprocessor to drive the movable mirror so as to align the first direction with the direction of reception and
using the microprocessor to determine the location of the second equipment, knowing the location of the first equipment, the relative height between the two equipments and the vertical and horizontal tilt angles of the mirror.

According to one embodiment, the first equipment and the second equipment are each equipped with an optical fiber carrying a light beam and with a movable mirror driven so as to direct the light beam at the output of the optical fiber in a certain direction, and the method comprises:
aligning the light beams by driving the orientation of the mirrors at vertical and horizontal tilt angles of the first equipment and of the second equipment so as to achieve optical transmission of data between the optical fiber of the first equipment and the optical fiber of the second equipment via an aerial medium,
determining the location of the second equipment, knowing the location of the first equipment, the relative height between the two equipments and the vertical and horizontal tilt angles of the mirror of the first equipment.

Another subject of the invention is a method for optical data communication between multiple first telecommunications equipments the location of which is known and multiple second telecommunications equipments, each equipment being equipped with an optical fiber carrying a light beam and with a movable mirror driven so as to direct the light beam at the output of the optical fiber in a first direction, and being equipped with a photoreceiver array for receiving a luminous flux carrying an identifier from another equipment taken from among the first and second equipments and for determining a direction of reception, comprising:
aligning the light beams by driving the orientation of the mirrors of the 1^{st} equipments and of the second equipments so as to achieve optical transmission of data between the optical fiber of one equipment from among the 1^{st} equipments and the optical fiber of another equipment from among the second equipments via an aerial medium,
determining the location of the other equipment, knowing the location of the equipment, the relative height between these two equipments and vertical and horizontal tilt angles of the mirror of the equipment.

Another subject of the invention is a telecommunications equipment intended to communicate with a second equipment, which comprises:
an optical fiber carrying a light beam,
a driven movable mirror,
a microprocessor for driving the orientation of the mirror at vertical and horizontal tilt angles so as to direct the light beam at the output of the optical fiber in a first direction,
a photoreceiver array for receiving a luminous flux carrying an identifier from an emitting source associated with a headset and for determining a direction of reception,
   and such that the microprocessor is designed to align the first direction with the direction of reception and to determine the location of the second equipment, knowing the location of the equipment, the relative height between the two equipments and the vertical and horizontal tilt angles of the mirror.

Another subject of the invention is an optical data communication system comprising a first telecommunications equipment the location of which is known and a second telecommunications equipment, the first equipment comprising:
a first optical fiber carrying a light beam,
a first movable mirror,
a first microprocessor for driving the orientation of the first mirror at vertical and horizontal tilt angles so as to direct the light beam at the output of the first optical fiber in a first direction,
a first photoreceiver array for receiving a luminous flux carrying an identifier from an emitting source associated with the second equipment and for determining a first direction of reception,
   the second equipment comprising:
a second optical fiber carrying a light beam,
a second movable mirror,
a second microprocessor for driving the orientation of the second mirror at vertical and horizontal tilt angles so as to direct the light beam at the output of the second optical fiber in a second direction,
a second photoreceiver array for receiving a luminous flux carrying an identifier from an emitting source associated with the first equipment and for determining a second direction of reception,
   the first microprocessor being designed to align the first direction with the first direction of reception, and the second microprocessor being designed to align the second direction with the second direction of reception,
   the system is such that the first microprocessor is designed to determine the location of the second equipment, knowing the location of the first equipment, the relative height between the two equipments and the vertical and horizontal tilt angles of the first mirror.

Knowing the location of the headset makes it possible, at any time, to adapt a virtual reality content item to the movements of the user, and thus to obtain an interaction between the user and the data that they perceive. Their sensation is therefore enhanced, and they become an actor in the content item that they are visualizing.

In addition, knowing the location of the headset makes it possible to anticipate situations where users risk being outside the zone of action or zone of discovery or even colliding.

Determining the various groups of identifiers, including a group of identifiers distinguishing each second equipment-first equipment pair (for example headset-access point) in the process of pairing, enables a headset and an access point to immediately determine which access point is available. This determination makes it possible to smooth a handover between access points when the user moves. The invention thus makes it possible to avoid communication interruptions even in the event of a handover from one access point to another.

Another subject of the invention is a computer program on an information medium, said program comprising program instructions suitable for implementing a method according to the invention when said program is loaded and executed in a telecommunications equipment.

Another subject of the invention is an information medium comprising program instructions suitable for implementing a method according to the invention when said program is loaded and executed in a telecommunications equipment.

According to one embodiment, the driving of the orientation of the mirrors is slaved to an indicator of the quality of communication between the first equipment and the second equipment so as to track a movement of this second equipment.

According to one embodiment, the location is determined at a certain rate.

According to one embodiment, the second equipment has its location communicated to it.

According to one embodiment, the second equipment is a virtual reality headset using virtual reality data, and the location of the headset is taken into account in order to adapt the virtual reality data used by the headset.

According to one embodiment, the determination of the relative height between the two equipments takes into account the height of a user of the headset.

According to one embodiment, the second equipment is a virtual reality headset using virtual reality data, the location of at least this headset is communicated to a virtual reality data server and the server adapts virtual reality data on the basis of the location in order to adapt the virtual reality data used by the headset.

According to one embodiment, the first equipment is taken from among multiple first telecommunications equipments the location of which is known and the second equipment is taken from among multiple second telecommunications equipments, each equipment being equipped with an optical fiber carrying a light beam and with a movable mirror driven by a microprocessor so as to direct the light beam at the output of the optical fiber in a first direction, and being equipped with a photoreceiver array for receiving a luminous flux carrying an identifier from another equipment taken from among the first and second equipments and for determining a direction of reception, and the method comprises:
for each of the first equipments, aligning the first direction with the direction of reception by using the microprocessor to drive the movable mirror,
using each first equipment from among the multiple first equipments to determine the location of a second equipment from among the multiple second equipments, knowing the location of the first equipment, the relative height between these two equipments and vertical and horizontal tilt angles of the mirror of the first equipment.

According to one embodiment, the first equipments and the second equipments are each equipped with a directional emitter of an identifier, multiple groups of identifiers are distinguished, including a first group of specific identifiers assigned respectively to first equipments, a second group of specific identifiers assigned respectively to second equipments and a third group of identifiers for second equipment/first equipment pairs in the process of pairing, and a directional emitter of at least one of the equipments directionally transmits a luminous flux carrying a transmitted identifier the value of which is taken from one of the groups according to its state.

According to one embodiment, an available equipment transmits its own identifier.

According to one embodiment, an unavailable equipment transmits an identifier other than its own identifier.

According to one embodiment, a first equipment paired with a second equipment transmits the identifier of the second equipment.

According to one embodiment, a first equipment in the process of pairing with a second equipment transmits the identifier taken from the third group that corresponds to the second equipment/first equipment pair.

The various embodiments may optionally be combined with one another so as to form another embodiment of the invention according to one of the subjects.

### LIST OF THE FIGURES

Other features and advantages of the invention will become more clearly apparent on reading the following description of embodiments, which are given by way of simple illustrative and non-limiting examples, and the appended drawings, in which:

FIG. 1 is a diagram of one embodiment of a system according to the invention,

FIG. 2 is a diagram of an access point AP and a headset UT of the system of FIG. 1, illustrating the principle of mounting the optical parts of each of these equipments according to one embodiment of the invention,

FIG. 3 is a flowchart illustrating the pairing process as it takes place on the headset side,

FIG. 4 is a flowchart illustrating the pairing process as it takes place on the access point side,

FIG. 5 is a schematic view of a hall in which only one access point AP and one headset UT of a system according to FIG. 1 are shown.

### DESCRIPTION OF PARTICULAR EMBODIMENTS

A first general principle of the invention is based on determining the position of a non-fixed equipment, for example a headset, knowing the position of the first equipment with which it is paired, the angles of orientation, for example azimuth and elevation, of the mirror of the first equipment, for example an access point, the communication flow reflected by the mirror of the first equipment pointing in the direction of the non-fixed equipment.

A second general principle of the invention is based on distinguishing multiple groups of identifiers assigned to the equipments of the system and on the directional transmission, by an equipment, of its identifier, the transmitted identifier possibly being different from its own identifier depending on its available or unavailable state. A first group comprises identifiers specific to headsets. A second group comprises identifiers specific to access points, and a third group comprises identifiers for a pairing in progress state.

The fact that the pairing process uses the three groups of identifiers enables a headset not to start pairing with an access point that is already in the process of pairing or has already paired, and to immediately identify available access points.

The directional transmission of the identifier enables a receiver of this transmission to be able to determine the direction of arrival of this transmission.

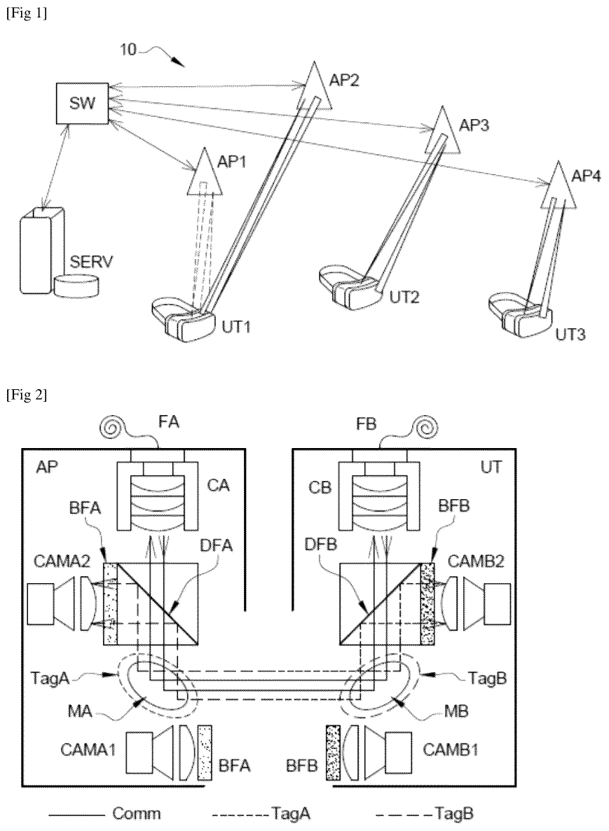

FIG. 1 is a diagram of one embodiment of a system according to the invention.

The system comprises at least one content server SERV, an optical switch SW, access points AP, AP1, . . . . AP4 referred to as first equipments and user headsets UT, UT1, . . . , UT3 referred to as second equipments. According to one embodiment, a method 10 for optical data communication according to the invention takes place between a first telecommunications equipment AP, taken from among the access points AP1, . . . . AP4, the location of which is known, and a second telecommunications equipment UT taken from among the user headsets UT1, . . . , UT3.

The equipments AP and UT are used in an environment that corresponds, according to one particular use, to a room bounded by a ceiling, a floor and walls. A certain number of access points are fixed to the ceiling. The X-position and Y-position of these access points, in a reference frame that may be Cartesian and parallel to the plane of the ceiling, is known to the headsets and to each access point. A vertical Z-axis may be defined parallel to the plane of a wall. The height between an access point and the floor is known to the headsets. Each access point covers an area within the space bounded by the walls, the floor and the ceiling. The height of the headset worn by a user is determined when the headset is assigned to the user, either knowing the height of the user or for example by a sighting system that makes it possible to measure the height of the headset worn by the user relative to the floor.

The server is connected to the optical switch via a high-speed link. Each access point is connected to the optical switch via a first optical fiber. The first optical fiber that arrives at an access point has its end on the access point side interfaced with a collimator so as to leave this free end oriented toward the floor and to transmit the optical flux into the air, possibly with a slight divergence.

Each headset is equipped with a second optical fiber, one end of which is interfaced with a collimator so as to leave this free end oriented toward the ceiling when the headset is worn by a user and to transmit the optical flux into the air, possibly with a slight divergence.

The communication signal, on the downlink, is transmitted from the server to the headset via the optical switch, the first optical fiber and the access point with airborne transmission of a luminous flux carrying this signal between the access point and the headset at a first wavelength, for example 1550 nm.

The communication signal, on the uplink, is emitted by the headset and guided by the second optical fiber with airborne transmission of a luminous flux carrying this signal between the headset and the access point at, optionally, a second wavelength, and then transmission to the server via the first optical fiber and the optical switch.

FIG. 2 is a diagram of an access point AP and a headset UT illustrating the principle of mounting the optical parts of each of these equipments according to one embodiment of the invention.

Each equipment AP, respectively UT, comprises an optical fiber FA, respectively FB, an optical collimator CA, respectively CB, two cameras, a coarse camera CAMA1 and a fine camera CAMA2, respectively CAMB1 and CAMB2, a tilting mirror MA, respectively MB, an optical bandpass filter BFA, respectively BFB, a dichroic filter DFA, respectively DFB, and a ring of LEDs TagA, respectively TagB.

The dichroic filter DFA, respectively DFB, makes it possible to separate two types of optical flux. Thus, one type of flux is transmitted by the filter, while the other type of flux is reflected.

The optical bandpass filter BFA, respectively BFB, makes it possible to eliminate unwanted residual light such as sunlight or artificial light and to let through the wavelengths of the communication signals transmitted between the access point and the user headset.

The ring of LEDs TagA, respectively TagB, is arranged around the mirror MA, respectively MB, and is integral with this mirror. This ring of LEDs is a directional emitter.

The optical fiber FA of the access point has a first end connected to the optical switch OC and a second end interfaced with the collimator CA. The communication signal (or data plane) is transported by this optical fiber FA and is destined for the user headset UT.

The optical fiber FB of the headset has a first end connected to an optical source (not shown) (for example an optical transceiver), and a second end interfaced with the collimator CB.

The collimator CA, respectively CB, thus if necessary adapts the optical flux transmitted by the optical fiber FA, respectively FB, into a parallel beam, possibly with a slight divergence, in free space, typically air.

The transmission (for example of a virtual content item) by the optical fiber FA, respectively FB, is bidirectional. In the downlink direction, the optical flux from the optical switch is transmitted into the air at the output of the collimator CA, filtered by the dichroic filter DFA, reflected by the mirror MA and then by the mirror MB, filtered by the dichroic filter DFB, received by the collimator CB, transmitted by the optical fiber FB and displayed to the user of the headset UT. In the uplink direction, the optical flux from the headset UT is transmitted into the air at the output of the collimator CB, filtered by the dichroic filter DFB, reflected by the mirror MB and then by the mirror MA, filtered by the dichroic filter DFA, received by the collimator CA and transmitted by the optical fiber FA to the switch.

The ring of LEDs TagA, respectively TagB, emits a luminous flux at a certain wavelength λA, respectively λB, typically in the infrared. The wavelengths λA, λB are preferably different, thereby making it possible to detect them better and distinguish them better from one another, for example 800 nm and 890 nm, respectively. These wavelengths are also very different from the wavelengths of the optical fluxes transmitted by the optical fibers FA and FB (1577 and 1270 nm for example). The wavelengths λA, λB are processed by the bandpass filters BFA and BFB, the mask of which includes the wavelengths λA, λB.

The luminous flux emitted by the ring of LEDs TagA, respectively TagB, is directional and is reflected by the mirror MB, respectively MA, reflected by the dichroic filter DFB, respectively DFA, filtered by the filter BFB, respectively BFA, and then detected by the coarse camera CAMB1 and by the fine camera CAMB2, respectively by CAMA1 and by CAMA2.

The coarse camera CAMA1, respectively CAMB1, has a wide field of view. The fine camera CAMA2, respectively CAMB2, has a narrow field of view that is more precise than that of the coarse camera CAMA1, respectively CAMB1.

The combination of the two coarse cameras and the two fine cameras defines a localization and tracking system for localizing and tracking either an access point or a user headset. The coarse camera CAMA1, respectively CAMB1, makes it possible to roughly locate a user headset, respectively an access point, and thus to determine the vertical and horizontal angles of rotation to be applied to the mirror MB, respectively MA, with what is referred to as a coarse precision, as detailed below, and these angles are referred to as coarse. After rotations of the mirror MB, respectively MA, along the two axes, by the values of the coarse angles determined beforehand, the fine camera CAMA2, respectively CAMB2, makes it possible to finely locate a user headset, respectively an access point, and thus to determine what are referred to as the fine angles of rotation to be applied to the mirror MB, respectively MA, with what is referred to as a fine precision, as detailed below. The rotation of the mirrors makes it possible to track the movement of the headset such that the loss of received power due to misalignment of the optical beams with the collimators is small. Thus, after the fine rotation, it is easy to determine the angles along the vertical, referred to as elevation, and along the horizontal, referred to as azimuth, corresponding to the resulting angles of rotation, coarse plus fine, by which the mirror has rotated overall.

The local mirror MA, respectively MB, in cooperation with the remote mirror MB, respectively MA, makes it possible to reflect and orient the uplink, respectively downlink optical flux in the direction of the collimator CA, respectively CB.

A rotation motor rotating about two axes of the mirror MA, respectively MB, makes it possible to pivot this mirror at an azimuth angle and an elevation angle so as to orient the optical flux in the desired direction. This motor is driven by a microcomputer or microprocessor (not shown).

The optical flux may be pointed in the direction of a collimator in two steps.

In a first step, the coarse camera CAMB1, respectively CAMA1, detects the luminous flux coming from the ring of LEDs TagA, respectively TagB, of an access point AP, respectively of a user headset UT. The microcomputer, in association with this coarse camera and on the basis of the distribution of the power received on the photodetector array of this camera, determines the coarse angles of rotation, elevation and azimuth, to be applied to the luminous flux so that the received power is maximized. Based on these coarse angles of rotation, the microcomputer determines the angle setpoints to be sent to the motor of the mirror in order thus to roughly align the luminous flux received by the collimator.

In a second step, the fine camera CAMB2, respectively CAMA2, detects the luminous flux coming from the ring of LEDs TagA, respectively TagB, of an access point AP, respectively of a user headset UT. The microcomputer, in association with this fine camera and on the basis of the distribution of the power received on the photodetector array of this camera, determines the fine angles of rotation, elevation and azimuth, to be applied to the luminous flux so that the received power is maximized. Based on these fine angles of rotation, the microcomputer determines the angle setpoints to be sent to the motor of the mirror in order thus to finely align the luminous flux received by the collimator.

The angles, azimuth and elevation, of the mirror MA, respectively MB, make it possible to ascertain the direction of the optical flux coming from the headset UT, respectively from the access point AP.

In an initial position, the mirror MA of the access point AP is substantially horizontal, so that the luminous flux leaving the optical fiber FA is directed toward the floor.

An access point AP thus serves a single user headset UT at a given time. However, by combining a multiple access technique, such as time division multiple access (TDMA), an access point is able to serve multiple users simultaneously with time division multiplexing. Other access techniques may be used, such as CDMA (code division multiple access) or FDMA (frequency division multiple access).

Each equipment transmits an identifier coded on a certain number of bits to the one or more other equipments in visibility of the emitted luminous flux via a coded transmission implemented by its ring of LEDs TagA, respectively TagB, for an access point AP, respectively for a user headset UT.

### Distribution and Assignment of Identifiers

Depending on the number of bits available to code the identifiers, the table below gives, for a certain number of headsets UT and access points AP, exemplary implementations according to the invention of the distribution and assignment of identifiers. According to the invention, a distinction is drawn between multiple groups of identifiers, one for headsets, one for access points and one for the various possible pairs of equipments in the process of pairing (access point AP-headset UT).

### [Table]

| No. of bits | | 5 | 7 | 9 | 11 | 13 |
|---|---|---|---|---|---|---|
| No. of UT | | 2 | 10 | 20 | 35 | 16 |
| No. of AP | | 10 | 10 | 23 | 55 | 480 |
| Group of | UT ID | From 0 to 1 | From 0 to 9 | From 0 to 19 | From 0 to 34 | From 0 to 15 |
| identifiers | AP ID | From 2 to 11 | From 10 to 19 | From 20 to 42 | From 35 to 89 | From 16 to 495 |
| | Pairing | From 12 to 31 | From 20 to 119 | From 43 to 502 | From 90 to 2014 | From 496 to 8175 |
| | ID | | | | | |

Thus, with five bits (equivalent to 32 binary possibilities), it is possible, according to the table, to distribute ten access points and to have two user headsets in the hall at the same time. The group of identifiers assigned to the headsets comprises values between zero and one. The group of identifiers assigned to the access points comprises values between two and eleven. The group of identifiers assigned to the access point-headset pairs in the process of pairing comprises values between twelve and thirty-one. Indeed, a pairing identifier identifies exactly the pair of equipments in the process of pairing, and it is the one transmitted by both equipments throughout the pairing process. For example, an identifier equal to fourteen indicates that access point two is in the process of pairing with headset zero. The emitter of the identifier is controlled by the microcomputer or microprocessor that gives it the value to be transmitted.

According to one embodiment of the invention, an equipment in operating mode transmits an identifier via the ring of LEDs TagA, TagB at all times. To distinguish between the binary bits of the identifier, OOK (ON/OFF keying) modulation or any other type of modulation may be used.

With OOK modulation, when the LEDs are on, this is for example a binary one, and when the LEDs are off, this is for example a binary zero. This transmission may also be carried out according to a certain protocol with one or more start bits and one or more stop bits.

One implementation of the invention is described below in the context of an amusement park that offers users the opportunity to immerse themselves in virtual reality. The content server contains one or more virtual reality scenarios having a corresponding content item, such as a video file, that is intended to be displayed on a headset UT. Audio may optionally be associated with the video content item.

This immersion is offered to one or more users who are, at the same time, in a hall equipped with multiple access points in a configuration compatible with the principles described above.

The access points transmit their identifier via their ring of LEDs at all times. A headset that is not assigned to a user is in idle mode.

When a headset is assigned to the user, the height of the headset worn by the user from the floor is determined. This height may then be provided to the headset and to the access points via for example a wireless communication between the equipments and a control system housed in a computer comprising a data entry interface. According to one alternative, the control system may make it possible to configure a removable storage space able to be inserted into the headset.

If multiple scenarios are offered, the user chooses a scenario from among the various scenarios. This selection may be entered via the control system and provided to the access points and to the headset.

The headset changes over or is changed over to operating mode for example as soon as it is assigned to the user or when the user wearing their headset enters the hall, the ring of LEDs, TagB, then transmits the identifier of the headset.

### Pairing Process

Communication between a headset and an access point requires pairing between these two equipments. The pairing process is completed when the headset and the access point “exchange” their identifier: the identifier transmitted by the headset is the one assigned to the access point (its own identifier) and the identifier transmitted by the access point is the one assigned to the headset (its own identifier).

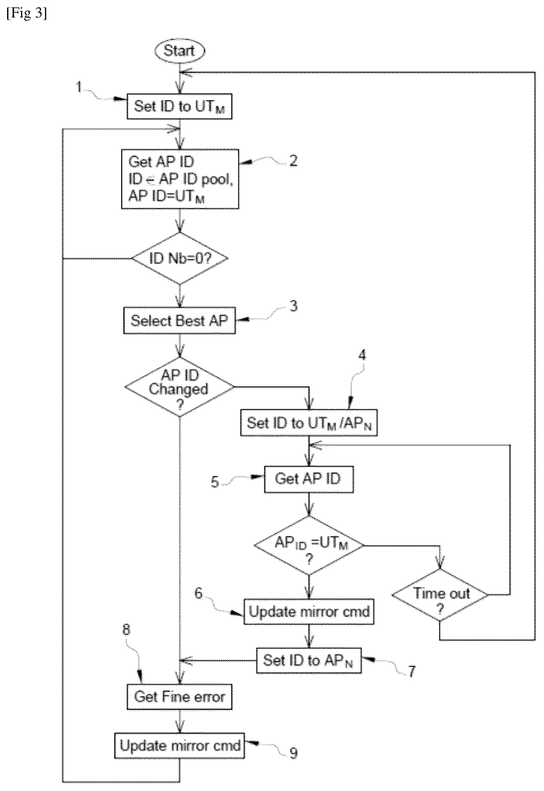

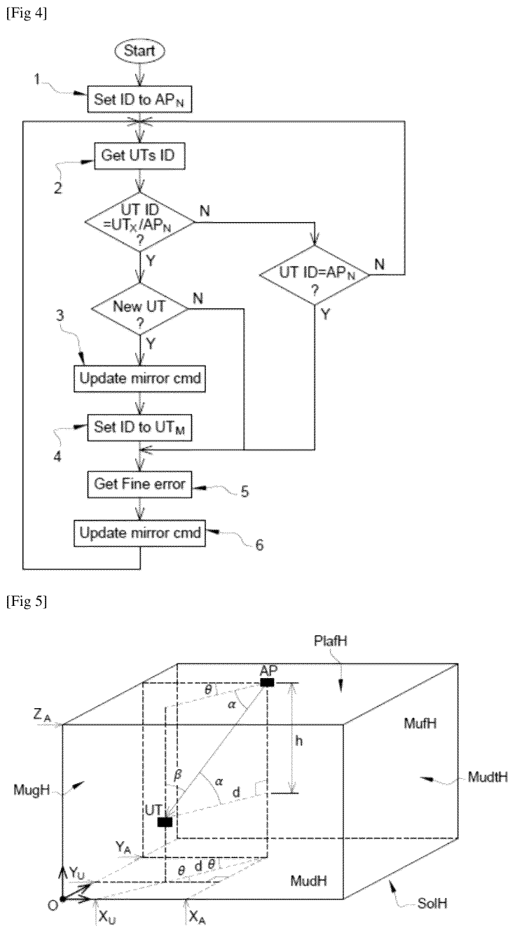

The pairing process is illustrated by the flowchart of FIG. 3 for the sequence on the headset side and by the flowchart of FIG. 4 for the sequence on the access point side, according to one exemplary implementation.

According to the above example in the first column of the table, the identifier assigned to the access point, which is a personal and unique identifier, that is to say its own identifier, has the value 2, a value taken from among 10 values of the group of access point identifiers. And the identifier assigned to the headset, which is a personal and unique identifier, has the value 1, a value taken from among 2 values of the group of headset identifiers. A headset may transmit only its personal identifier, or an identifier contained in the set of pairing identifiers or the identifier of the access point with which the headset is paired. An access point may transmit only its personal identifier, or an identifier contained in the set of pairing identifiers or the identifier of the headset with which the access point is paired.

### Pairing on the Headset Side

With reference to FIG. 3, the start of the pairing process, start, may correspond to the time when the headset is changed over from idle mode to operating mode.

In a first step, Set ID to UT_{M}, the headset updates its identifier, and the identifier takes the value of the personal identifier of the headset, 1 according to the example. This identifier is transmitted by the ring of LEDs, TagB, of the headset.

In a second step, the headset uses its coarse camera to detect the various luminous fluxes coming from the various rings of LEDs TagA, etc. of the various access points installed in the hall that its photodetector array receives. The headset identifies the identifiers of the detected access points, GET APs ID. Among these detected access points, the headset determines those that are available ID∈AP ID pool and those that are paired OR AP ID=UT_{M}. An available access point transmits an identifier with a value taken from among the set of identifier values reserved for the access points, a set of 10 values according to the example. If an access point is not available, then it may already be paired and the identifier that it transmits is that of a headset, AP ID=UT_{M}. Headset 0 may already be paired with an access point, and in this case the identifier transmitted by this access point is that of the headset, for example if the headset is paired with access point 3, then the headset transmits the identifier 3 and the access point transmits the identifier 0.

Following the second step, the headset carries out a first test: are all detected access points busy, that is to say unavailable, AP ID Nb=0? If none of the detected access points is available, the response to the test is positive, then the process loops back to the second step, and the headset continues its detection of an access point. If at least one access point is available, that is to say one of the detected access point identifiers belongs to the group of access point identifiers, the response to the test is negative, and the process moves to a third step.

In this third step, the headset selects the best access point from among the available detected access points, Select Best AP. The coarse camera of the headset covers a certain field of view. In this field, it is able to detect and identify multiple available access points, that is to say the coarse camera is able to use its sensor, for example an array of optical detectors, to receive multiple fluxes each forming a ring or part of a ring. Depending on the position of the rings or parts of rings on its sensor, the coarse camera is able to identify that one of the rings or parts of rings closest to its center. The headset that receives the flux transmitted by this ring or part of a ring via its coarse camera is able to decode the identifier transmitted by this ring in order to determine the corresponding access point from among the various detected access points, that is to say the nearest available access point.

The headset carries out a second test: does the identifier of the nearest available access point change, AP ID changed? Although this test occurs after the third step, it may take place concomitantly with this third step and, generally speaking, throughout the entire pairing method. The headset determines, via this test, whether the identifier of the nearest available access point changes over a certain period. Thus, by comparing, at the end of a certain period, the identifier of the detected nearest available access point with the one detected at the start of this period, the method is able not to take into account changes of identifier that could be due to round trips made by the user.

If the result of the second test is negative, that is to say the identifier of the nearest available access point has not changed, the headset moves to an eighth step.

If the result of the second test is positive, that is to say the identifier of the nearest available access point has changed, there is a transition to a pairing process, and the headset moves to a fourth step. This change may correspond to a need for a handover from a first access point to another access point due for example to the headset being moved away from the first access point with which it is paired, as illustrated for the headset UT1 in FIG. 1, which has moved away from the access point AP2 and is attempting to change over to the access point AP1.

In a fourth step, the headset changes its identifier transmitted by its ring of LEDs so as to give it the association value corresponding to this nearest available access point, Set ID to UT_{M}/AP_{N}, according to the example by taking the value, between 12 and 31, that indicates that headset 1 is attempting to pair with access point 2.

The headset continues, fifth step, Get AP ID, with its detection of the identifier of this nearest available access point for as long as this access point has not confirmed it has paired with the headset by taking the identifier of the headset, UTₘ ID, according to the example by changing over from the identifier 2 to the identifier 1.

The headset carries out a third test, AP ID=UT_{M}?: has the identifier transmitted by this access point changed to the value of the personal identifier of the headset to confirm or not confirm pairing between the headset and this access point. According to the example, this is tantamount to testing whether the identifier transmitted by the access point has changed from 2 to 1, the personal identifier of the headset.

The detection of the change may be associated with a timeout, Time out?, in order to loop back to the fifth step during this timeout for as long as no change is detected.

If, at the end of the timeout, the access point has not confirmed pairing, the headset loops back to the first step.

If the result of the third test is positive, that is to say the identifier of the access point has taken the value of the personal identifier of the headset signifying that the access point has accepted pairing with the headset, the headset moves to the sixth step.

In the sixth step, Update mirror cmd, the headset uses the coarse camera detection to determine the coarse angles of rotation to be applied to the mirror of the headset in order to bring the ring coming from the access point that has accepted the pairing to the center of the reception array of the coarse camera.

In the seventh step, the headset informs the access point that it has paired with the access point by updating its identifier with the value of the identifier of the access point, Set ID to AP_{N}. According to the example, the value of the identifier displayed by the headset was the association value UT₁/AP₂. To signify its pairing, the identifier displayed by the headset takes the value 2, which corresponds to the personal identifier of the access point.

The headset may additionally determine, step eight, Get Fine error, using the detection of its fine camera, the fine angles of rotation to be applied to the mirror of the headset in order to bring the ring coming from the access point with which the headset has paired more precisely to the center of the reception array of the fine camera. This step also makes it possible to maintain the centralization of the optical flux in the event of the user moving.

The headset drives the rotation of the mirror with the fine angles of rotation, step nine, Update mirror cmd.

Once the rotation is complete, the pairing method implemented by the headset loops back to the second step.

This method allows the user to move around the hall while still maintaining uninterrupted communication between the headset and the server by virtue of the pairing being handed over from one access point to another.

### Pairing on the Access Point Side

The start of the pairing process, start, may correspond to the time when the access point is changed over from idle mode to operating mode. The coarse camera of each access point detects the various rings of LEDs TagB, etc. of the various headsets present within its field of view (coverage).

In a first step, Set ID to AP_{N}, the access point updates its identifier, and the identifier takes the value of the personal identifier of the access point, a value of 2 according to the example, taken from among a set of 10 values. This identifier is transmitted by the ring of LEDs, TagA, of the access point.

In a second step, the access point uses its coarse camera to receive the various luminous fluxes coming from the various rings of LEDs TagB, etc. of the various headsets present in the hall and present within its coverage. The access point identifies, GET UTs ID, the identifiers of the detected headsets.

Among these, the access point AP determines whether a headset is in the process of pairing therewith in a first test, UT ID=UTx/AP_{N}?, that is to say for the example the identifier of the group of pairing identifiers corresponding to the pair UT₁/AP₂.

If the result of the first test is negative, that is to say the identifier of the headset is not the one indicating pairing in progress with the access point, then the method carries out a second test, UT ID=AP_{N}?, to determine whether the headset is already paired with the access point AP_{N}, according to the example UT ID=1?

If the result of the second test is positive, that is to say the identifier of the headset is that of the access point, the headset is already paired with the access point, then the method moves to the fifth step (Get fine error).

If the result of the second test is negative, that is to say the identifier of the headset is not that of the access point, the headset is not already paired with this access point, the headset has just unpaired or else it is in the process of pairing or has already paired with another access point, then the method returns to the second step.

If the result of the first test is positive, that is to say the identifier of the headset is the one indicating pairing in progress with the access point, then the method carries out a third test, New UT?, to determine whether this identifier of a headset in the process of pairing has not changed for a certain time. Thus, by comparing, at the end of a certain period, the identifier of the headset in the process of pairing with the one at the start of this period, the method is able not to take into account changes of headset identifiers that could be due to round trips made by the user.

If the result of the third test is negative, that is to say the identifier of the headset in the process of pairing has not changed in the certain time, the method moves to the fifth step (Get fine error).

If the result of the third test is positive, that is to say the identifier of the headset in the process of pairing has changed in the certain time, the access point determines, Update mirror cmd, third step, using the detector of its coarse camera, for example an array of optical detectors, the coarse angles of rotation to be applied to its mirror in order to bring the ring coming from the headset to the center of the reception array of the coarse camera.

The access point informs the headset of its agreement to pair by updating the identifier that it transmits, fourth step, Set ID to UT_{M}. The identifier transmitted by the access point takes the value of the identifier of the headset, and therefore changes from the value 2 to the value 1 according to the example.

In the fifth step, the access point uses the fine camera detection to determine, Get Fine error, the fine angles of rotation to be applied to its mirror in order to bring the ring coming from the headset to the center of the reception array of the fine camera.

The access point drives the rotation of the mirror with the fine angles of rotation, step six, Update mirror cmd.

Once the rotation is complete, the pairing method implemented by the access point loops back to the second step.

### Location of the Headset

FIG. 5 is a diagram of a hall used for use of the invention in a virtual reality application context. The hall has a floor solH, a ceiling PlafH, a back wall MufH, a left wall MugH, a right wall MudtH and a front wall MudH. A single access point AP and a single headset UT are shown in this hall to simplify the description. Of course, the hall may be equipped with multiple access points and multiple users each provided with a headset may be present in the hall at the same time, and what is described for one access point or one headset applies to the other access points and headsets. Each user enters and leaves the hall independently of the other users or at the same time. An angle of the hall is considered to be the origin O of an orthogonal Cartesian reference frame consisting of a horizontal plane, for example the floor SolH, and a vertical axis, for example along the left wall MugH. The coordinates (^{x}_{A}, ^{y}_{A}, ^{z}_{A}) of the access point are known in this reference frame.

The tilt angles of the mirror MA of the access point make it possible to ascertain the direction of the optical flux emanating from the access point and directed for example toward the headset UT (User terminal). The projection of this optical flux onto the plane of the ceiling PlafH forms an angle θ with respect to a vertical plane parallel to the back wall MufH, this angle θ corresponding directly to the tilt angles of the mirror. The projection of this optical flux onto a vertical plane parallel to the left wall MugH and passing through the access point forms an angle β with respect to the vertical. The angle α of the optical flux with respect to a horizontal plane passing through the headset is deduced from the angle β: α=90−β. Knowing the height of the headset from the ground and the height at which the access point is positioned from the ground, it is therefore possible to determine the relative height h between the headset and the access point.

It is thus possible to determine the distance d of the headset in line with the access point on the horizontal plane passing through the headset: d=h/tan α□

By projecting the optical flux onto the horizontal plane SolH, it is possible to determine the abscissa ^{x}_{U} and the ordinate ^{y}_{U} of the headset in the orthogonal Cartesian reference frame:

$${x}_{U} = {x}_{A} - d cos θ$$

$${y}_{U} = {y}_{A} - d sin θ$$

Knowing the coordinate ^{z}_{A} of the access point and the relative height h between the headset and the access point, it is possible to determine the coordinate ^{z}_{U} of the headset:

$${z}_{U} = {z}_{A} - h$$

Knowing the coordinates (^{x}_{U}, ^{y}_{U}, ^{z}_{U}) gives the location of the headset UT precisely in the orthogonal Cartesian reference frame.

The access point is able to compute the coordinates of the headset (^{x}_{U}, ^{y}_{U}, ^{z}_{U}) based on its knowledge of its coordinates (^{x}_{A}, ^{y}_{A}, ^{z}_{A}), the tilt angles of its mirror, which give it the angles α and θ, and h.

According to one embodiment, the headset may transmit its coordinates (^{x}_{U}, ^{y}_{U}, ^{z}_{U}) to the data server so that the latter modifies the virtual reality data intended for the headset by adapting them to the location of the headset. The user of the headset is thus able to benefit from a display of virtual data adapted to their location. By changing position, the user is thus able to interact with the virtual reality application and obtain displayed data that take their position into account.

According to another embodiment, the access point may transmit the coordinates (^{x}_{U}, ^{y}_{U}, ^{z}_{U}) to the headset. The latter may adapt the received virtual reality data to its location itself.

1. A method for optical data communication between a first telecommunications equipment at a known location and a second telecommunications equipment, the first equipment being equipped with an optical fiber carrying a light beam and with a movable mirror driven by a microprocessor so as to direct the light beam at an output of the optical fiber in a first direction, and being equipped with a photoreceiver array for receiving a luminous flux carrying an identifier from the second equipment and for determining a direction of reception, the method comprising:
using the microprocessor to drive the movable mirror so as to align the first direction with the direction of reception; and
using the microprocessor to determine a location of the second equipment, knowing the location of the first equipment, a relative height between the two equipments and vertical and horizontal tilt angles of the mirror.

2. The method of claim 1, wherein the driving of the orientation of the mirror is slaved to an indicator of the quality of communication between the first equipment and the second equipment so as to track a movement of this second equipment.

3. The method of claim 1, wherein the location is determined at a certain rate.

4. The method of claim 1, further comprising the second equipment having its location communicated to it.

5. The method of claim 1, wherein the second equipment is a virtual reality headset using virtual reality data, and wherein the method further comprises taking into account the location of the headset in order to adapt the virtual reality data used by the headset.

6. The method of claim 5, wherein determination of the relative height between the two equipments takes into account the height of a user of the headset.

7. The method of claim 1, wherein the second equipment is a virtual reality headset using virtual reality data, the method further comprising:
communicating the location of at least this headset to a virtual reality data server,
communicating, to at least this headset, virtual reality data adapted by the server on the basis of the location of at least this headset.

8. The method of claim 1, the first equipment being taken from among multiple first telecommunications equipments the location of which is known and the second equipment being taken from among multiple second telecommunications equipments, each equipment being equipped with an optical fiber carrying a light beam and with a movable mirror driven by a microprocessor so as to direct the light beam at the output of the optical fiber in a first direction, and being equipped with a photoreceiver array for receiving a luminous flux carrying an identifier from another equipment taken from among the first and second equipments and for determining a direction of reception, the method further comprising:
for each of the first equipments, aligning the first direction with the direction of reception by using the microprocessor to drive the movable mirror, and
using each first equipment from among the multiple first equipments to determine the location of a second equipment from among the multiple second equipments, knowing the location of the first equipment, the relative height between these two equipments and vertical and horizontal tilt angles of the mirror of the first equipment.

9. The method of claim 8, the first equipments and the second equipments each being equipped with a directional emitter of an identifier, the method further comprising:
distinguishing multiple groups of identifiers, including a first group of specific identifiers assigned respectively to first equipments, a second group of specific identifiers assigned respectively to second equipments and a third group of identifiers for second equipment/first equipment pairs in the process of pairing, and
a directional emitter of at least one of the equipments from among the first and second equipments directionally transmitting a luminous flux carrying a transmitted identifier the value of which is taken from one of the groups according to its state.

10. The method of claim 9, wherein an available equipment transmits its own identifier.

11. The method of claim 9, wherein an unavailable equipment transmits an identifier other than its own identifier.

12. The method of claim 11, wherein a first equipment paired with a second equipment transmits the identifier of the second equipment.

13. The method of claim 11, wherein a first equipment in the process of pairing with a second equipment transmits the identifier taken from the third group that corresponds to the second equipment/first equipment pair.

14. A telecommunications equipment intended to communicate with a second equipment, the equipment comprising:
an optical fiber carrying a light beam,
a driven movable mirror,
a microprocessor for driving an orientation of the mirror at vertical and horizontal tilt angles so as to direct the light beam at an output of the optical fiber in a first direction, and
a photoreceiver array for receiving a luminous flux carrying an identifier from an emitting source associated with a headset and for determining a direction of reception, wherein the microprocessor drives the orientation of the mirror so as to align the first direction with the direction of reception and to determine a location of the second equipment, knowing a location of the equipment, a relative height between the two equipments and the vertical and horizontal tilt angles of the mirror.

15. An optical data communication system comprising a first telecommunications equipment at a known location and a second telecommunications equipment, the first equipment comprising:
a first optical fiber carrying a light beam,
a first movable mirror,
a first microprocessor for driving an orientation of the first mirror at vertical and horizontal tilt angles so as to direct the light beam at an output of the first optical fiber in a first direction, and
a first photoreceiver array for receiving a luminous flux carrying an identifier from an emitting source associated with the second equipment and for determining a first direction of reception,
the second equipment comprising:
a second optical fiber carrying a light beam,
a second movable mirror,
a second microprocessor for driving an orientation of the second mirror at vertical and horizontal tilt angles so as to direct the light beam at an output of the second optical fiber in a second direction, and
a second photoreceiver array for receiving a luminous flux carrying an identifier from an emitting source associated with the first equipment and for determining a second direction of reception, the first microprocessor aligning the first direction with the first direction of reception, and the second microprocessor aligning the second direction with the second direction of reception, wherein the first microprocessor determines a location of the second equipment, knowing the location of the first equipment, a relative height between the two equipments and the vertical and horizontal tilt angles of the first mirror.
